(19) United States
(12) Patent Application Publication
(10) Pub. No.: US 2021/0195587 A1
(43) Pub. Date: Jun. 24, 2021

(54) BROADCAST OPERATION WITH BI-DIRECTIONAL SUBFRAME SLOTS IN MULTIBEAM DEPLOYMENT

(71) Applicant: Nokia Technologies Oy, Espoo (FI)

(72) Inventors: Jorma Johannes Kaikkonen, Oulu (FI); Sami-Jukka Hakola, Kempele (FI); Jarkko Tuomo Koskela, Oulu (FI)

(21) Appl. No.: 17/053,692

(22) PCT Filed: Apr. 26, 2019
(86) PCT No.: PCT/EP2019/060700

§ 371 Date: Nov. 6, 2020

Related U.S. Application Data
(60) Provisional application No. 62/670,348, filed on May 11, 2018.

(51) Int. Cl. H04W 72/04; H04L 5/00

(52) U.S. Cl. CPC H04W 72/0446; H04L 5/0091

(57) ABSTRACT

Methods and apparatus, including computer program products, are provided for use of bi-directional slots of a subframe. In some example embodiment, there may be provided an apparatus that includes at least one processor and at least one memory including computer program code, the at least one memory and the computer program code configured to, with the at least one processor, cause the apparatus to at least determine a threshold indicative of downlink symbol availability in at least one bi-directional slot of a subframe and monitor for an occasion covering the at least one bi-directional slot, when the threshold indicates the availability of downlink symbols in the at least one bi-directional slot. Related systems, methods, and articles of manufacture are also described.

### FIELD

The subject matter described herein relates to wireless.

### BACKGROUND

The cellular system including the Fifth Generation (5G) system may support an increasing number of devices and services including applications with a wide range of use cases and diverse needs with respect to bandwidth, latency, and reliability requirements. For example, multiple input, multiple output technology may be used to increase throughput/data rate. The system may also be configured to support machine-to-machine communications as well as ultra-reliable, low latency services.

### SUMMARY

Methods and apparatus, including computer program products, are provided for use of bi-directional slots of a subframe.

In some example embodiment, there may be provided an apparatus that includes at least one processor and at least one memory including computer program code, the at least one memory and the computer program code configured to, with the at least one processor, cause the apparatus to at least determine a threshold indicative of downlink symbol availability in at least one bi-directional slot of a subframe and monitor for an occasion covering the at least one bi-directional slot, when the threshold indicates the availability of downlink symbols in the at least one bi-directional slot.

In some variations, one or more of the features disclosed herein including the following features can optionally be included in any feasible combination. The threshold may provide an indication of a current usage of downlink symbols in a bi-directional slot and corresponding available symbols in the bi-directional slot which can serve as the occasion. The occasion may include a paging occasion, other system information occasion, and/or a random access response.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts an example of a UL-DL slot pattern including a bi-directional, flexible slot, in accordance with some example embodiments;

FIG. 2 depicts an example of a system including a user equipment configured to utilize paging occasions including at least one bi-directional slot, in accordance with some example embodiments;

FIG. 3 depicts an example of a process for utilizing paging occasions including at least one bi-directional slot, in accordance with some example embodiments;

FIG. 4 depicts an example of an apparatus, in accordance with some example embodiments;

FIG. 5 depicts block candidate location patterns, in accordance with some example embodiments; and

FIG. 6 depicts an example search space on the physical downlink control channel, in accordance with some example embodiments.

Like labels are used to refer to same or similar items in the drawings.

### DETAILED DESCRIPTION

In the cellular system including the Fifth Generation (5G) cellular system, paging will be more complex, when compared to prior cellular systems, due to many of 5G's features, such as multiple input, multiple output technology (MIMO), for example. As such, the user equipment (UE) task of determining when there is a paging occasion to monitor a page is more complex. The paging occasion (which is within a paging frame) defines a specific time during which a UE checks for a paging message.

For paging, the cellular network may provide to the UE information including parameters. These parameters may be received, via signaling, broadcast, and/or the like, and these parameter may include the paging occasion configuration, such as time offset in a frame, duration, periodicity, and/or the like. Moreover, the physical downlink control channel (PDCCH) configuration may provide the UE with the search space configuration including the monitoring occasions within a paging occasion. For paging, the core resource set (CORESET) configuration may reuse the same configuration for the remaining minimum system information (RMSI) CORESET as indicated in the physical broadcast channel (PBCH). In addition, the UE may assume quasi-colocation (QCL) between synchronization signal (SS) blocks, paging downlink control information/indicators (DCs), and paging messages. Moreover, the UE may not be required to soft combine multiple paging DCIs within one paging occasion. Furthermore, the air interface support by the UE and base station may also support the sending of so-called “short paging messages,” such as a systemInfoModification, cmas-Indication, and/or etws-Indication, as part of the paging DCI.

MIMO technology, as noted, may be supported, so multi-beam operations may increase the complexity of paging. To that end, the length in time (e.g., duration) of a paging occasion may be set to one period of a beam sweep, and the same paging message may be repeated in all beams of the sweeping pattern. As such, a single paging occasion may cover the entire beam sweep, so a UE's monitoring pattern may take this into account as well.

The UE may receive from the network a system information block (SIB), such as a SIB type 1. When this is the case, the SIB 1 may provide the UE with information to enable uplink (UL) and downlink (DL) slot configuration. For example, the UL/DL slot configuration may be determined via one or two concatenated slot patterns, which repeat in time to form an Uplink/Downlink time division duplex (TDD) configuration. The configuration for each pattern indicates the slots of a subframe defined as downlink slots (“D”) containing only DL symbols, bi-directional (e.g., flexible, ‘X’) slots allowing both downlink and uplink symbols, or uplink only slots (‘U’) containing only UL symbols.

The pattern may have a time period configured that is based in part on the sub-carrier spacing to enable a determination of the slots within a subframe of a frame. The configuration for each pattern may provide the quantity (e.g., number) of DL only slots (from the start of the time period), the quantity of DL symbols from the start of the slot that are deemed bi-directional, the quantity of UL only slots (from the end of the time period), and the quantity of UL symbols from the end of the slot that are deemed as bi-directional. Slots that fall within the time period, and are not set as DL-only or UL-only slots are bi-directional slots. The slot represents a subframe portion associated with at least one symbol.

To illustrate further, a UE may be scheduled to receive, in the downlink, only in DL symbols (“D”) portion or the flexible symbols (“X”) portion. Similarly, the UE may be schedule to transmit only in the UL symbols (“U”) portion or flexible symbols (“X”) portion. For the flexible slots (which would be the remaining slots among the DL only (“D”) slots and UL only (“U”) slots), the symbol partition in the flexible slots may be determined. This may be determined by determining the number of DL only symbols (from the start of the slot) and UL only symbols (from the end of the slot), while the remaining symbols in between may be considered flexible symbols.

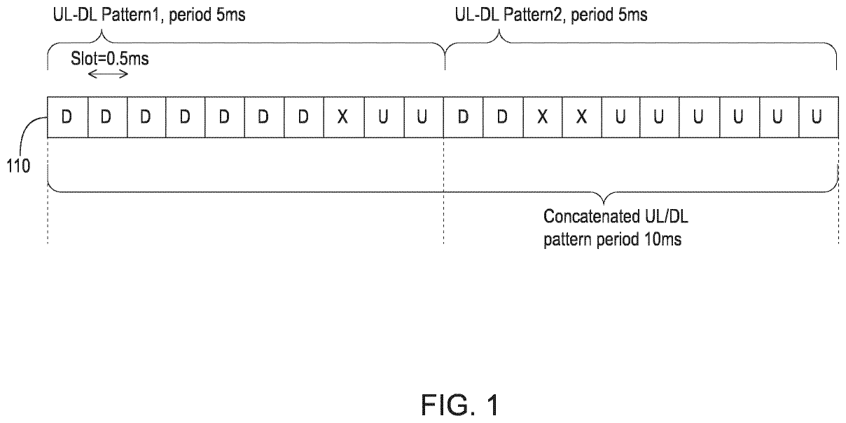

FIG. 1 depicts an example of a flexible UL/DL configuration pattern 110 showing the slots in the subframe allocated to a downlink transmission (labeled D), allocated to an uplink transmission (labeled U), and the flexible slots (labeled X) which can be allocated flexibly to the uplink or the downlink, as noted. The pattern 110 may repeat over a period, such as over a time period of a frame, beam sweep, and/or the like. For example, a beam sweep may represent a beam at a given time and location.

3GPP 38.213 explains that for random access channel (RACH) occasion mapping, if a UE is provided a first higher layer parameter (e.g., tdd-UL-DL-ConfigurationCommon) or is also provided second, higher layer parameter (e.g., tdd-UL-DL-ConfigurationCommon2), the valid physical RACH (PRACH) occasions are those occasions that include uplink symbols or flexible symbols that start at least N_{gap} symbols after a last downlink symbol or a last SS/PBCH block transmission symbol where N_{gap} is provided in table, such as Table 1 below (which may be in accordance with a standard, see, e.g., Table 8.1-2 in 3GPP TS 38.213; see also R1-1805795, 3GPP TSG-RAN1, Meeting #92bis, Sanya, China, Apr. 16-20, 2018), as a function of the preamble subcarrier spacing value. For preamble format B4 for example, the N_{gap}=0. In the case of RACH occasion, these occasions may represent when the UE may send a PRACH, which can also be monitored by the base station.

TABLE 1

| Preamble subcarrier | |
|---|---|
| spacing | N_{gap} |
| 1.25 kHz or 5 kHz | 0 |
| 15 kHz or 30 kHz or 60 | 2 |
| kHz | |
| 120 kHz | 2 or 3 |

The time domain resource allocation (RA) for the physical downlink shared channel (PDSCH) may be performed via the 4 bit resource allocation field of the DCI. The default interpretation of the resource allocation field may be determined in accordance with a standard, such as 3GPP TS 38.214, although the time domain resource allocation may be provide to, and configured at, the UE via broadcast or dedicated signaling from the network, such as a base station including the new radio (NR) node B (gNB). The supported physical downlink shared channel (PDSCH) allocation sizes may be for the Type A primary synchronization channel (PSCH) mapping (3, . . . , or 14) and for the physical downlink shared channel (PDSCH) Type B (e.g., sub-slot based scheduling) mapping (2, 4, or 7). This physical downlink shared channel (PDSCH) mapping type may be provided by the PDSCH time domain resource allocation, which may be in accordance with a standard, such as 3GPP TS 38.214.

In Long Term Evolution (LTE), the paging frame (PF) calculation indicates where in the radio frame the UE needs to listen for paging. The paging occasion calculation may have subframe accuracy to enable the UE to listen to a paging DCI (which is the indicator/information allocating resources for the paging message).

In the 5G new radio (NR) system, the paging occasion calculation may not be as straightforward as in previous generations of wireless systems, in which fixed time division duplex (TDD) patterns and fixed numerology with respect to frame structure are implemented. In the 5G NR's numerology, there can be variations in the subcarrier spacing of 15 kHz, 30 kHz, 60 kHz, and 120 kHz for data and control, and these variations also affect slot allocations as well. Moreover, the 5G NR's flexible TDD patterns (in which any slot of a subframe can be configured as a downlink slot, an uplink slot, or a flexible slot) may lead to variation that makes paging occasion determination more complex, when compared to previous cellular systems. Indeed, the determination of the paging occasion can, if not property performed, lead to discrepancies and wasted power and resources.

In order to enable the base station, such as a 5G New Radio (NR) gNB base station, beam sweep to be performed during the paging occasion, the duration of the paging occasion may need to be extended to cover multiple slots of a subframe of a frame. Depending on the paging occasion time/location, certain slots during the beam sweep may be of type DL (D) only, UL (U) only, or flexible (X).

Although uplink slots (U) may not be useable by the UE to receive a page, downlink slots may be used. With respect to the flexible (X) slots, their usage by the UE to receive a page may depends on a variety of factors. Similarly, the system information (SI) window may need to cover an entire beam sweep over which different types of slots may be present. Moreover, the RACH response (RAR) window may be 10 ms for example, which with 120 kHz carrier spacing translates to 80 slots, so enforcing the slots to be DL only slots (or, for example, with very limited UL allocation) may heavily and inefficiently restrict DL/UL allocations.

In some example embodiments, the user equipment (UE) may determine the validity of bi-directional slots (e.g., the flexible, X slots depicted at FIG. 1) for scheduling of a paging occasion. This determination may be based on the condition of the quantity of available symbols. In some example embodiments, this determination may be based on a threshold, which is further described below.

Alternatively or additionally, the UE may determine the validity of bi-directional slots (e.g., the flexible, X slots) for RAR scheduling or other system information (OSI) window reception. This determination may be based on the condition of the quantity of available symbols. In some example embodiments, this determination may be based on a threshold, which is further described below.

In some example embodiments, the UE may determine, based on a threshold, the validity of a bi-directional slot (e.g., the flexible, X slot) for scheduling of paging occasion or monitoring of RAR, OSI, and/or the like. For example, the threshold may provide an indication of the availability of downlink (DL) symbols. Specifically, the availability of DL symbols given expected allocations and/or usage at a given time and/or location. If there are an insufficient amount of DL symbols to serve the expected allocations and/or usage, the bi-directional symbols (X) will likely be allocated to satisfy the expected allocations and/or usage, rather than paging (or some other type of monitoring occasion). If however there are a sufficient amount of DL symbols to serve the expected allocations and/or usage, the corresponding bi-directional slot(s) can be used for paging, so the UE can monitor the paging occasion in at least one bi-directional slot.

In some example embodiments, the threshold may be defined in accordance with the following:

Th_{symb}^{DL}=N_{symb}^{PDSCH}+N_{symb}^{CORESET} Equation 1,

wherein N_{symb}^{PDSCH} is the quantity (e.g., number) of symbols to be assumed in use for the physical downlink shared channel (PDSCH) resource allocation (RA), and N_{symb}^{CORESET} is the number of symbols used for the CORESET allocation as given by a management information block (e.g. through ‘pdcch.ConfigSIB1’ or via dedicated signalling for example in case of handover or redirection or some other higher layer signalling). For example, the values of N_{symb}^{PDSCH} and N_{symb}^{CORESET} may be parameters associated with a slot. When this is the case, if a slot has 14 symbols, the N_{symb}^{CORESET} will have a value less than 14, such as 1, 2, or 3, while the N_{symb}^{PDSCH} may have values anywhere between 1 and 12.

Equation 1 above may provide a threshold that prevents using bi-directional symbols (for a given slot) for monitoring a paging occasion on the physical downlink control channel (PDCCH), when there are an insufficient amount of symbols to satisfy the resource requirements of the CORESET and PDSCH. At a given location and a given time, the UE may use the bi-directional slots “X” for paging opportunities or other monitoring tasks, when, based on the threshold, there are available symbols given the symbol resource requirements for the CORESET and PDSCH.

The N_{symb}^{PDSCH} and N_{symb}^{CORESET} values may be determined in a semi-static manner (for example, defined in accordance with a specification, table, mapping table, and/or the like, or provided by higher layer signaling). Alternatively or additionally, the N_{symb}^{PDSCH} and N_{symb}^{CORESET} values may be determined implicitly and/or directly based on one or more other parameters. Alternatively or additionally, the N_{symb}^{PDSCH} and N_{symb}^{CORESET} values may be signaled separately (e.g., included in system information, such as a SIB).

In some example embodiments, the possible value for N_{symb}^{PDSCH} (or range of possible values) may be determined based on the physical downlink shared channel (PDSCH) allocation type {A,B}. For example, if PDSCH allocation type A (e.g., for slot based allocation) is used, the possible range of values for N_{symb}^{PDSCH} may be {8, 10, or 12}. And, if the PDSCH allocation type B (e.g., for mini-slot or non-slot based allocation) is used, the N_{symb}^{PDSCH} may be {2, 4, or 7}. The allocation type and N_{symb}^{PDSCH} may be provided as part of the paging configuration information or as part of system information provided to UE via broadcast signaling or via dedicated signaling.

In some example embodiments, the value for N_{symb}^{PDSCH} is determined based on the value of other parameter(s) as follows:
A) N_{symb}^{CORESET} size is accounted in the determination of valid value for the N_{symb}^{PDSCH}, when N_{symb}^{CORESET} may be {1, 2, or 3} and N_{symb}^{PDSCH} may take values among the group of possible values {2, 4, or 7}, if N_{symb}^{CORESET}=2, then N_{symb}^{PDSCH}=4, so that there is one to one or one to many mapping between the valid values of N_{symb}^{CORESET} and N_{symb}^{PDSCH};
B) Alternatively or additionally, the value of N_{RB}^{CORESET} can be accounted in the determination of valid values of r N_{symb}^{PDSCH}, for example when N_{RB}^{CORESET} may be {24, 48, or 96}, if the N_{RB}^{CORESET}=24 then N_{symb}^{PDSCH}=7, or in condition based manner so that when N_{RB}^{CORESET} takes value that ≤48, N_{symb}^{PDSCH} takes value 7, or when N_{RB}^{CORESET} takes value that >48, N_{symb}^{PDSCH}=4 (e.g., when the available bandwidth is lower than certain threshold use more symbols); and
C) Both N_{symb}^{CORESET} and N_{RB}^{CORESET} are accounted jointly to determine the value for N_{symb}^{PDSCH} for example by first determining the range possible range of values for N_{symb}^{PDSCH} based on the value of N_{RB}^{CORESET} and then based of value of N_{symb}^{CORESET} the value for N_{symb}^{PDSCH} is selected among the possible values.

Table 2 below presents an example of an implementation of example A above for determining the N_{symb}^{PDSCH} value for Equation 1. In example implementations consistent with A, B, or C, the UE may determine the value of N_{symb}^{PDSCH} based on given N_{symb}^{CORESET} and N_{RB}^{CORESET}. The value of N_{symb}^{CORESET} and N_{RB}^{CORESET} may be provided (or determined from) system information (e.g., based on a specification with tables such as Tables 2-4 below).

TABLE 2

| N_{symb}^{CORESET} | Value of N_{symb}^{PDSCH} |
|---|---|
| 1 | 7 |
| 2 | 4 |
| 3 | 2 |

Table 3 below presents an example of an implementation of example B above for determining the N_{symb}^{PDSCH} value for Equation 1.

TABLE 3

| N_{RB}^{CORESET} | Value of N_{symb}^{PDSCH} |
|---|---|
| 24 | 7 |
| 48 | 4 |
| 96 | 2 |

Table 4 presents an example of an implementation of example C above for determining the N_{symb}^{PDSCH} value for Equation 1.

TABLE 4
Value of N_{symb}^{PDSCH}

| N_{symb}^{CORESET} | N_{RB}^{CORESET} = 24 | N_{RB}^{CORESET} = 48 | N_{RB}^{CORESET} = 96 |
|---|---|---|---|
| 1 | 7 | 4 | 2 |
| 2 | 7 | 4 | 4 |
| 3 | 7 | 7 | 4 |

Determining the value assumed for N_{symb}^{PDSCH} in threshold determination based on N_{symb}^{CORESET} and/or N_{Rb}^{CORESET} would approximate the coverage requirement, as it can be assumed that the network determines the value for N_{symb}^{CORESET} and/or N_{RB}^{CORESET} (e.g., through parameter such as “pdcch-ConfigSIB1”) based on the required coverage level. The N_{symb}^{CORESET} and N_{RB}^{CORESET} provide an indication of the total amount of control channel elements (CCEs, such as resources) available for PDCCH and supported aggregation level, which in term indicates what coverage can be achieved with PDCCH.

The value of N_{RB}^{CORESET} determines the number of continuous resource blocks (RBs) for the CORESET (e.g., the frequency domain size). Based on 3GPP TS 38.213, the N_{RB}^{CORESET} for the CORESET Type0-DPCCH common search space may be determined by ‘pdcch-ConfigSB1’ based on the tables given in TS 38.213 section 13. For example, the CORESET of Type0A-DPCCH (OSI DPCCH) and Type2-DPCCH (paging PDCCH) common search space share the same CORESET configuration as Type0-DPCCH common search space.

In some example embodiments, the value assumed for N_{symb}^{PDSCH}, accounts for the presence of a SS/PBCH block candidate location or the presence of an actually transmitted SS/PBCH block in the slot. For example, if UE is provided by higher-layer signaling the presence of SS/PBCH block in a slot (e.g., for rate matching purposes), the value assumed for N_{symb}^{PDSCH} may account for the presence of SS/PBCH block (e.g., so that the value of N_{symb}^{PDSCH} is increased). Alternatively or additionally, this may be accounted for in determination of the threshold as follows:

Th_{symb}^{DL}=N_{symb}^{PDSCH}+N_{symb}^{CORESET}+N_{symb}^{SSB} Equation2,

wherein N_{symb}^{SSB} value is conditioned on the presence of SS/PBCH block candidate location(s) or actually transmitted SS/PBCH block(s) in the slot. In addition or alternatively, the value of N_{symb}^{SSB}, if SS/PBCH block is present, may depend on, for example, the value N_{RB}^{CORESET}, so that if the value of N_{RB}^{CORESET} is larger than (or equal to) certain threshold, N_{symb}^{SSB}=2, and if value of N_{RB}^{CORESET} is below (or equal to) certain threshold, N_{symb}^{SSB}=4. This may be used for example to account the needed rate matching of the paging message. In addition or alternatively, the value of N_{symb}^{SSB} may depend on the sub-carrier spacing of SS/PBCH block, and its relation to sub-carrier spacing assumed for paging (or some other type of monitoring occasion). The N_{RB}^{CORESET} represents a frequency domain allocation of CORESET (control resource set) indicating how many resource blocks (RBs) the CORESET is having in frequency domain. In NR, one RB can have Equation subcarriers in frequency.

For each flexible slot (“X”) in a subframe, until all needed monitoring occasions are covered, the possibility of a monitoring occasion to be placed in a bi-directional (flexible, X) slot is determined based on comparing the number of available DL symbols to the determined threshold. The bi-directional (flexible) slot may thus contain the valid search space location (e.g., monitoring occasions), when the quantity of available DL symbols in the bi-directional (flexible) slot, N_{symb}^{DL}, is equal or larger than Th_{symb}^{DL}, in other words the N_{symb}^{DL}≥Th_{symb}^{DL}.

The number of available DL symbols, N_{symb}^{DL}, may be determined based on the provided DL/UL slot configuration and signaled RACH configuration (occasions, PRACH configuration index). For the slots, where there are no RACH occasions present, the value for N_{symb}^{DL} may be based on the total number of DL symbols and flexible symbols configured. If RACH occasions are possible in the slot, the number of available DL symbols would be determined based on the following:

N_{symb}^{DL}=N_{symb}^{slot}−N_{start symb}^{RACH}+N_{gap} Equation 3,

wherein:
N_{symb}^{slot} may be obtained (in accordance with, for example, section 4.3.2 of TS 38.211) based on sub-carrier spacing and cyclic prefix (e.g., normal, extended CP) and may corresponds to the total number of symbols in slot,
N_{start symb}^{RACH} may be obtained based on PRACH configuration index from random access configuration tables (see, e.g. TS 38.21), and
N_{gap} is obtained from a table, such as Table 1 above.

Alternatively or additionally, the presence of an SS/PBCH block candidate location or the presence of an actually transmitted SS/PBCH block in the slot may be accounted for in the determination of number of available DL symbols, N_{symb}^{DL}. For example, by reducing from the available DL symbols, by symbols that overlap with SS/PBCH candidate locations or symbols that overlap with the actually transmitted SS/PBCH blocks (or for example determining the number of available DL symbols so that only those DL symbols that are present before the first symbol of actually transmitted SS/PBCH block are accounted or so that only contiguous DL symbols before or after SS/BPCH blocks are accounted in determining the number of available DL symbols).

Alternatively or additionally, number of available paging or monitoring (RAR monitoring and/or the like) occasions within the flexible slot may be determined as

$${N}_{occ}^{DL} = ⌊ \frac{{N}_{symb}^{DL}}{{Th}_{symb}^{DL}} ⌋ .$$

When N_{occ}^{DL} takes value that is equal or greater than the number of desired paging or monitoring (RAR and/or the like) occasions, then the bi-directional (flexible) slot includes a number of valid paging or monitoring occasions, where the number could be determined by N_{occ}^{DL}.

In some example embodiments, the N_{occ}^{DL} may be used to determine the number of valid monitoring occasions in the bi-directional (flexible) slot. In some example embodiments, a condition may be set to value of N_{occ}^{DL}, so that if the condition exceeds the value of N_{occ}^{DL} then the slot in question could be used for paging scheduling, and contain for example N_{occ}^{Paging} monitoring occasions.

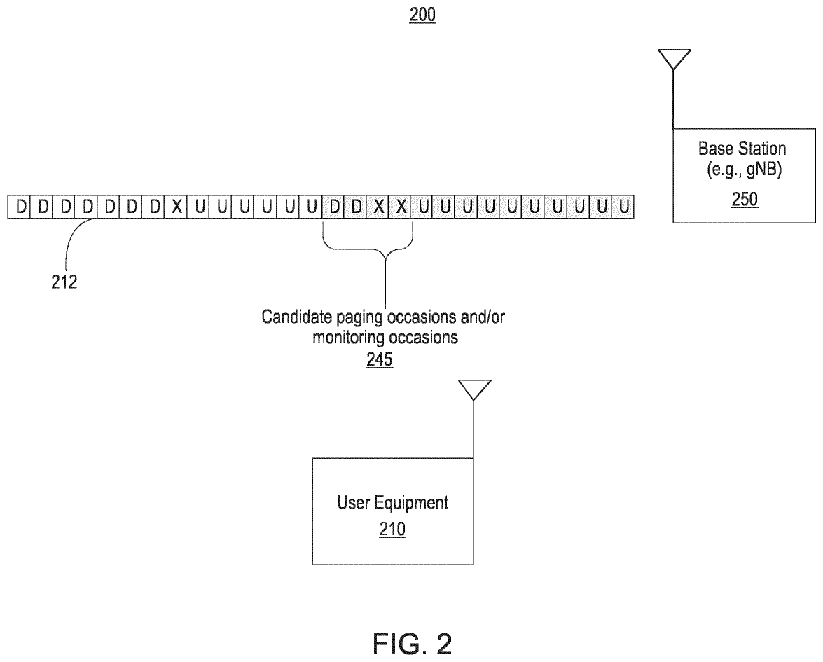

FIG. 2 depicts an example of a portion of a wireless system 200 including at least one user equipment (UE) 210 and at least one base station 250, in accordance with some example embodiments.

The UE 210 may be configured to wirelessly couple to a radio access network being served by a wireless access point, such as a base station 250, which may be referred to as New Radio (NR) 5G gNB base station. The base station 250 may provide to the UE 210 information that enables the UE to determine the whether a bi-directional slot can be used for a paging and/or monitoring occasion. For example, the base station may provide information to enable a determination of the N_{symb}^{PDSCH} and N_{symb}^{CORESET} values and/or provide other system or management information to enable a determination of a threshold as described in Equation 1, for example. The UE 210 may then monitor slots 245 including at least one bi-directional slot associated with a paging occasion and/or monitoring occasion, when the threshold indicates the availability of DL symbols.

The base station 250 may be coupled to core network, which may include an access and mobility management function (AMF), a visiting session management function (V-SMF), a visiting policy control function (v-PCF), a visiting network slice selection function (v-NSSF), a visiting user plane function (V-UPF), and/or other nodes as well.

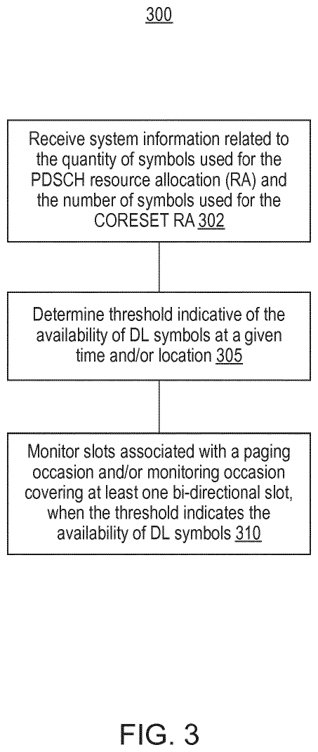

FIG. 3 depicts an example of a process 300 for determining whether a bi-directional slot of a subframe may monitored as a paging occasion, in accordance with some example embodiments.

Although some of the examples describe the use of the threshold to determine a paging occasion, the threshold may be used to determine other monitoring occasions of information broadcast from the base station including other system information, random access response (RAR), and/or the like.

At 302, a user equipment may receive from a network node system information including information indicative of the symbols being used for the physical downlink shared channel (PDSCH) resource allocation (RA) and the number of symbol being used for the CORESET resource allocation, in accordance with some example embodiments. For example, the user equipment may receive from a base station, such as a New Radio gNB base station, system information as part of a master information block and/or system information block. This information may directly or indirectly provide information related to the values of the N_{symb}^{PDSCH} and N_{symb}^{CORESET}. For example, the network may explicitly signal the N_{symb}^{PDSCH} and N_{symb}^{CORESET} values to the UE. Alternatively or additionally, the network may provide other parameters which can be used to determine the N_{symb}^{PDSCH} and N_{symb}^{CORESET} values. Alternatively or additionally, the network may provide the allocation type information, as noted above.

At 305, the UE may determine (or obtain) a threshold indicative of DL symbols at a given time and/or location, in accordance with some example embodiments. For example, the UE may determine the threshold based on Equation 1 above. The threshold provides an indication of the current usage of DL symbols in a bi-directional slot, and as such, whether there are any available symbols in the bi-directional slot which can serve as a paging occasion.

At 310, the UE may monitor for a paging occasion (and/or a monitoring occasion), covering at least one bi-directional slot, when the threshold indicates the availability of DL symbols in the at least one slot, in accordance with some example embodiments. As noted, the threshold provides an indication of the usage of DL symbols, so available DL symbols in a bi-directional slot may indicate a possible paging occasion or other type of monitoring occasion for the UE.

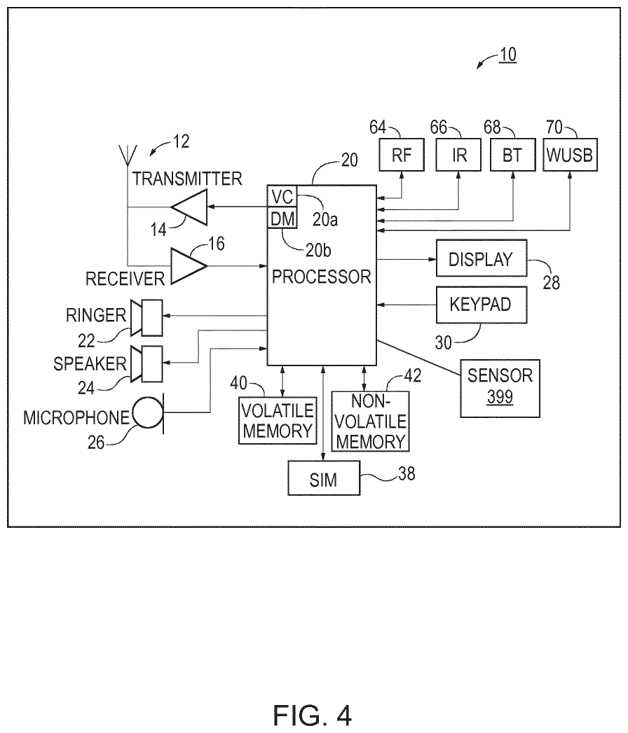

FIG. 4 illustrates a block diagram of an apparatus 10, in accordance with some example embodiments.

The apparatus 10 may represent a user equipment, such as the user equipment 210. The apparatus 10, or portions therein, may be implemented in other network nodes including base stations (e.g., devices 250).

The apparatus 10 may include at least one antenna 12 in communication with a transmitter 14 and a receiver 16. Alternatively transmit and receive antennas may be separate. The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 10 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 4 as a single processor, in some example embodiments the processor 20 may comprise a plurality of processors or processing cores.

The apparatus 10 may be capable of operating with one or more air interface standards, communication protocols, modulation types, access types, and/or the like. Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, fifth-generation (5G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced, 5G, and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 4, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth™ (BT) transceiver 68 operating using Bluetooth™ wireless technology, a wireless universal serial bus (USB) transceiver 70, a Bluetooth™ Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the Wi-Fi or wireless local area networking modem may also be capable of transmitting and/or receiving data from electronic devices according to various wireless networking techniques, including 6LoWpan, Wi-F, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), an eUICC, an UICC, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing operations disclosed herein including process 300 and/or the like. Alternatively or additionally, the apparatus may be configured to cause the operations disclosed herein with respect to the base stations/WLAN access points and network nodes including the UEs.

The memories may comprise an identifier, such as an international mobile equipment identification (IMEI) code, capable of uniquely identifying apparatus 10. The memories may comprise an identifier, such as an international mobile equipment identification (IMEI) code, capable of uniquely identifying apparatus 10. In the example embodiment, the processor 20 may be configured using computer code stored at memory 40 and/or 42 to the provide operations disclosed herein with respect to the base stations/WLAN access points and network nodes including the UEs including process 300 and/or the like.

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 4, computer-readable medium may comprise a non-transitory computer-readable storage medium that may be any media that can contain or store the instructions for use by or in connection with an instruction execution system, apparatus, or device, such as a computer.

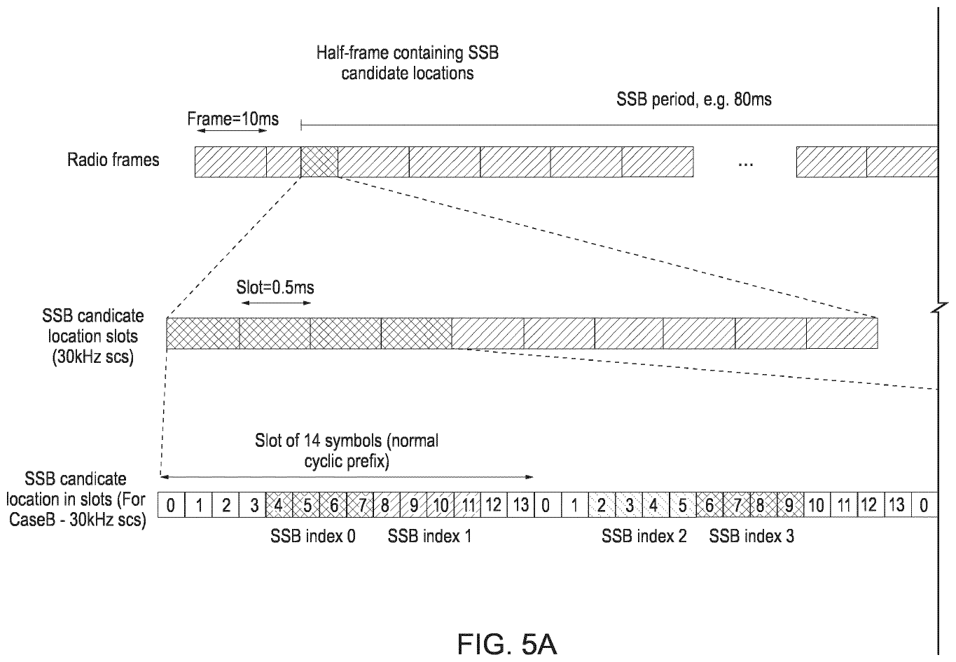

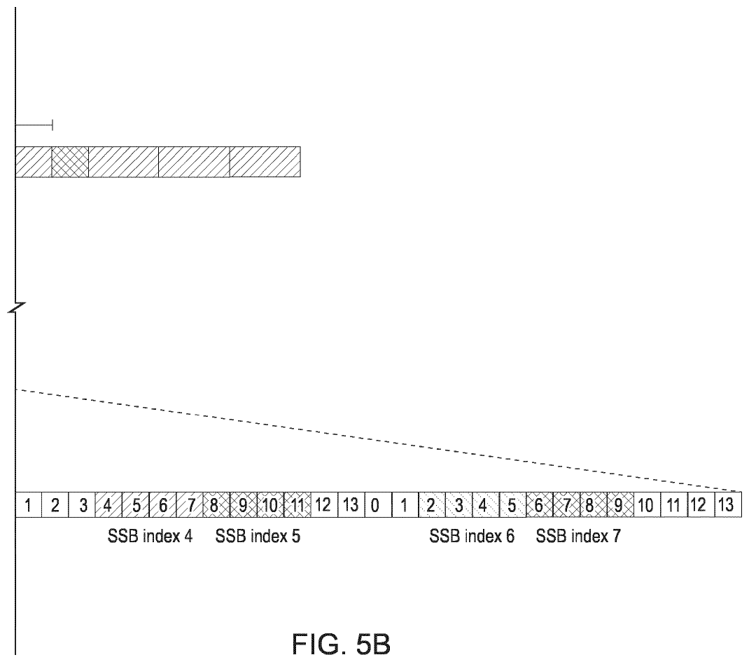

The following provides some additional description related to beam sweeping in the 5G New Radio. The UE may obtain time and frequency synchronization to a cell (and obtains the Cell-ID) through detecting SS/PBCH blocks (SSB). The SSB may contain the Primary Synchronization Signal (PSS), Secondary Synchronization Signal (SSS) and Primary Broadcast Channel (PBCH) together with Demodulation Reference Signals (DMRS) associated to PBCH (see, e.g., TS 38.213, section 4.1). The PSS and SSS may carry the Cell-ID via sequence initialization, and PBCH may carry Master Information Block (MIB) including DMRS, SSB index, and/or the like. To support beam forming, the SSB can be sent to different spatial direction in a time multiplexed manner. Candidate locations in a half-frame (5 ms) are illustrated in FIG. 5 for a certain use case at 30 kHz (see, e.g., Case B at TS 38.213].

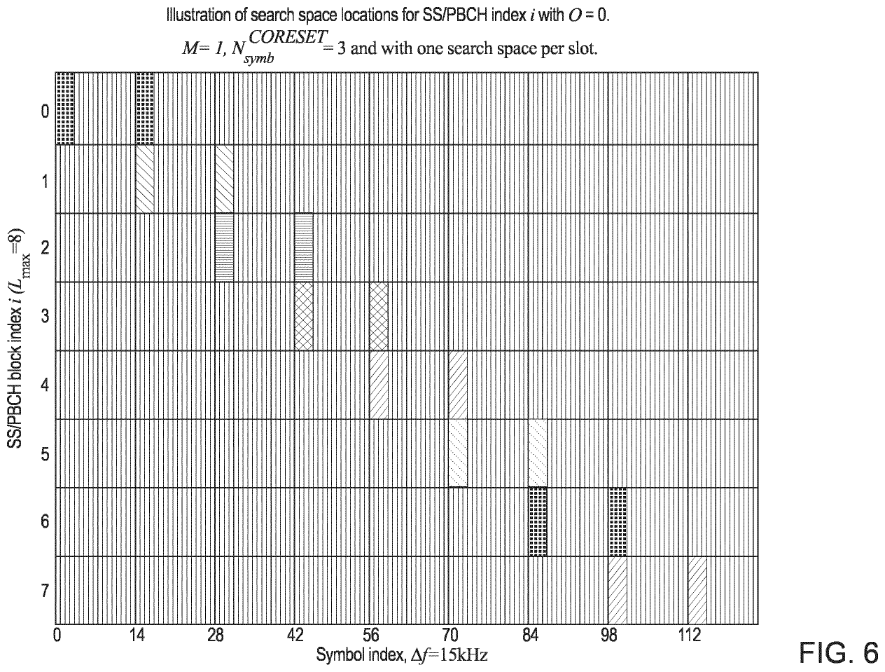

The pattern of SSBs sent in the half-frame pattern is repeated with a certain period (e.g., 5, 10, 20, 40, 80, or 160 ms). Correspondingly, for System Information Block 1 (SIB1), the UE is configured via MIB (‘pdcch-ConfigSIB1’) with monitoring pattern for Type0-PDCCH, scheduling the SIB1. This configuration gives the UE the length of the Control Resource Set (CORESET) in terms of symbols {e.g., 1, 2, or 3}, number of contiguous resource blocks (e.g., 24, 48, or 96}, frequency location of the CORESET (in relation to the SSB location), and the used pattern and parametrization for the monitoring pattern. For example for SS/PBCH and CORESET monitoring pattern 1 where monitoring occasion occurs every 20 ms, the UE may be given an offset (O) from the start of the radio frame (where occasions occur), with a shift (M) placing the monitoring occasion corresponding each SSB in time, together with the number of possible monitoring occasions per slot. Based on the detected SSB index and information provided by MIB, the UE may determine the monitoring occasion (search space) corresponding to each SSB index. FIG. 6 illustrates one realization of search space locations.

Without in any way limiting the scope, interpretation, or application of the claims appearing below, a technical effect of one or more of the example embodiments disclosed herein may be enhanced usage of bidirectional slots.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

1. An apparatus comprising:
at least one processor; and
at least one memory including computer program code, the at least one memory and the computer program code configured to, with the at least one processor, cause the apparatus to at least:
determine a threshold indicative of downlink symbol availability in at least one bi-directional slot of a subframe; and
monitor for an occasion covering the at least one bi-directional slot, when the threshold indicates the availability of downlink symbols in the at least one bi-directional slot.

2. The apparatus of claim 1, wherein the threshold provides an indication of a current usage of downlink symbols in a bi-directional slot and corresponding available symbols in the bi-directional slot which can serve as the occasion.

3. The apparatus of claim 1, wherein the occasion comprises a paging occasion, other system information occasion, and/or a random access response.

4. A method comprising:
determining a threshold indicative of downlink symbol availability in at least one bi-directional slot of a subframe; and
monitoring for an occasion covering the at least one bi-directional slot, when the threshold indicates the availability of downlink symbols in the at least one bi-directional slot.

5. The method of claim 4, wherein the threshold provides an indication of a current usage of downlink symbols in a bi-directional slot and corresponding available symbols in the bi-directional slot which can serve as the occasion.

6. The method of claim 4, wherein the occasion comprises a paging occasion, other system information occasion, and/or a random access response.

7. An apparatus comprising:
means for determining a threshold indicative of downlink symbol availability in at least one bi-directional slot of a subframe; and
means for monitoring for an occasion covering the at least one bi-directional slot, when the threshold indicates the availability of downlink symbols in the at least one bi-directional slot.

8. The apparatus of claim 7, wherein the threshold provides an indication of a current usage of downlink symbols in a bi-directional slot and corresponding available symbols in the bi-directional slot which can serve as the occasion.

9. The apparatus of claim 7, wherein the occasion comprises a paging occasion, other system information occasion, and/or a random access response.

10. A non-transitory computer-readable storage medium including program code which when executed causes operations comprising:
determining a threshold indicative of downlink symbol availability in at least one bi-directional slot of a subframe; and
monitoring for an occasion covering the at least one bi-directional slot, when the threshold indicates the availability of downlink symbols in the at least one bi-directional slot.

11. The non-transitory computer-readable storage medium of claim 10, wherein the threshold provides an indication of a current usage of downlink symbols in a bi-directional slot and corresponding available symbols in the bi-directional slot which can serve as the occasion.

12. The non-transitory computer-readable storage medium of claim 10, wherein the occasion comprises a paging occasion, other system information occasion, and/or a random access response.
